(19) United States
(12) Patent Application Publication
(10) Pub. No.: US 2024/0037785 A1
(43) Pub. Date: Feb. 1, 2024

(54) METHOD FOR MAPPING LOCATION CODES

(71) Applicant: Floatic Inc., Seoul (KR)

(72) Inventors: Seokhoon Jeong, Seoul (KR); Hoyeon Yu, Seoul (KR); Sucheol Lee, Seoul (KR); Seung Hoon Lee, Seoul (KR)

(21) Appl. No.: 18/227,036

(22) Filed: Jul. 27, 2023

(30) Foreign Application Priority Data
Aug. 1, 2022 (KR) 10-2022-0095666

(51) Int. Cl. G06T 7/73

(52) U.S. Cl. CPC G06T 7/74; G06T 2207/20112; G06T 2207/30252

(57) ABSTRACT

Provided is a method, which is performed by one or more processors, and includes receiving a first image captured at a specific location by a first monocular camera mounted on a robot, receiving a second image captured at the specific location by a second monocular camera mounted on the robot, receiving information on the specific location, detecting one or more location codes based on at least one of the first image or the second image, and estimating information on location of each of the one or more location codes based on the first image, the second image, and the information on the specific location.

### CROSS-REFERENCE TO RELATED APPLICATION

This application claims priority to Korean Patent Application No. 10-2022-0095666, filed in the Korean Intellectual Property Office on Aug. 1, 2022, the entire contents of which are hereby incorporated by reference.

### BACKGROUND

In recent years, logistics systems have been somewhat automated, in which robots may perform logistics-related tasks or assist workers in logistics-related tasks. Meanwhile, some logistics systems may use location codes for the convenience of logistics management. The location code may refer to a character format code which is designated in association with a specific place (e.g., a specific passage, a specific rack, a specific cell, etc.) in a distribution warehouse etc. where an object is stored so as to specify the specific place. Meanwhile, a human worker may be able to immediately understand the character format location code and look for the location of the location code, but a robot cannot immediately understand the character format location code or look for the corresponding location using the location code, which is problematic.

Descriptions in this background section are provided to enhance understanding of the background of the disclosure, and may include descriptions other than those of the prior art already known to those of ordinary skill in the art to which this technology belongs.

### SUMMARY

The following summary presents a simplified summary of certain features. The summary is not an extensive overview and is not intended to identify key or critical elements.

One or more aspects of the present disclosure relate to a method for mapping location codes (e.g., a method for mapping character format location codes by estimating location information of the location codes based on images of the location codes captured by a monocular camera).

One or more aspects of the present disclosure provides a method for mapping location codes for solving the problems described above.

The present disclosure may be implemented in a variety of ways, including a method, an apparatus (system, robot, etc.), or a non-transitory computer-readable recording medium storing instructions.

A method are provided, which may be performed by one or more processors and include receiving a first image captured at a specific location by a first monocular camera mounted on a robot, receiving a second image captured at the specific location by a second monocular camera mounted on the robot, receiving information indicating the specific location, detecting, based on at least one of the first image or the second image, one or more location codes, and estimating a location of each location code of the one or more location codes based on the first image, the second image, and the information indicating the specific location.

The detecting the one or more location codes may include detecting, using an Optical Character Recognition (OCR), the one or more location codes that are included in at least one of the first image or the second image.

The detecting the one or more location codes may include detecting character information included in at least one of the first image or the second image using OCR, and detecting, based on location code pattern, the one or more location codes from the detected character information.

The detecting the one or more location codes may include pre-processing the first image and the second image, and detecting, based on the pre-processed first image and the pre-processed second image, the one or more location codes based on the pre-processed images.

The pre-processing the first image and the second image may include cropping the first image such that an area in the first image that is associated with the one or more location codes remain in the cropped first image, and cropping the second image such that an area in the second image that is associated with the one or more location codes remain in the cropped second image.

The pre-processing the first image and the second image may include extracting the area in the first image that is associated with the one or more location code by performing an image segmentation on the first image, and extracting the area in the second image that is associated with the one or more location codes by performing an image segmentation on the second image.

The one or more location code may include codes attached to racks to distinguish partitioned areas of the racks, and the cropping the first image may include cropping the first image by using physical information of the racks such that the area in the first image that is associated with the one or more location codes remain in the cropped first image, and the cropping the second image may include cropping the second image by using the physical information of the racks such that the area in the second image that is associated with the one or more location codes remain in the cropped second image.

The pre-processing the first image and the second image may further include merging the cropped first image and the cropped second image.

The pre-processing the first image and the second image may include removing noise from the first image and the second image.

The information indicating the specific location may be location information estimated by the robot.

The estimating the location of each location code of the one or more location codes may include determining three-dimensional (3D) location information of each location code of the one or more location codes with respect to the robot, based on the first image, the second image, and the information indicating the specific location, and converting the 3D location information of each location code of the one or more location codes into global location information indicating a location of the one or more location codes in a global coordinate system.

The determining the 3D location information of each location code of the one or more location codes may include determining, by using physical information of a subject captured in the first image or the second image and a focal length of the first monocular camera or the second monocular camera, the 3D location information of each location code of the one or more location codes.

The determining the 3D location information of each location code of the one or more location codes may include determining 3D location information of each location code of the one or more location codes using triangulation.

A method are provided, which may be performed by one or more processors and include receiving a plurality of first images captured by a first monocular camera mounted on a robot, wherein each first image of the plurality of first images is captured at a location of a plurality of locations, receiving a plurality of second images captured by a second monocular camera mounted on the robot, wherein each second image of the plurality of second images is captured at a location of the plurality of locations, receiving information indicating the plurality of locations, detecting, based on at least one of the plurality of first images or the plurality of second images, a plurality of location codes, and estimating a location of each location code of the plurality of location codes based on the plurality of first images, the plurality of second images, and the information indicating the plurality of locations.

The method may further include performing at least one of removing an abnormal value form the information of an estimated location of at least one location code of the plurality of location codes, or correcting, based on a missing value, information of an estimated location of at least one location code of the plurality of location codes.

The removing the abnormal value may include eliminating the abnormal value by clustering locations where images having the plurality of location codes are captured.

The removing the abnormal value may include, based on locations of a set of location codes of the plurality of location codes, which are estimated to be on the same straight line, approximating a linear function associated with a set of location codes, and removing information of a location of a location code of the set of location codes, in which the location code of the set of location codes has a residual from the linear function exceeding a predefined threshold.

The correcting the information of the estimated location of each location code of the plurality of location codes may include, based on locations of a set of location codes of the plurality of location codes, which are estimated to be on the same straight line, approximating a linear function associated with the set of location codes, and compensating for the missing value based on information of a location of each location code of the set of location codes and the linear function.

The method may further include determining, based on the estimated location of each location code of the plurality of location codes, a picking location associated with each of the plurality of location codes.

The determining the picking location may include determining a picking location associated with a specific location code, and the determining the picking location associated with the specific location code may include, based on locations of a set of location codes estimated to be on the same straight line as the specific location code, approximating a linear function associated with the set of location codes, and determining a picking location present on a normal of the linear function passing through a location of the specific location code.

According to some examples of the present disclosure, it is possible to perform a mapping operation using existing facilities as they are, without the need to install an additional mark that can be recognized by the robot in the distribution warehouse.

According to some examples of the present disclosure, mapping can be performed with high accuracy at low cost by performing the mapping operation using a monocular camera.

According to some examples of the present disclosure, because it is possible to estimate the location information for the location code in the distribution warehouse, precise mapping is possible.

According to some examples of the present disclosure, by converting the location information of the cell into local location information based on the cell directing apparatus or the driving robot, it is possible to point to the target cell even if the location of the cell directing apparatus or the driving robot is not fixed and changes.

The effects of the present disclosure are not limited to the effects described above, and other effects not described herein can be clearly understood by those of ordinary skill in the art (referred to as “ordinary technician”) from the description of the claims.

These and other features and advantages are described in greater detail below.

### BRIEF DESCRIPTION OF THE DRAWINGS

The above and other objects, features and advantages of the present disclosure will be described with reference to the accompanying drawings described below, where similar reference numerals indicate similar elements, but not limited thereto, in which:

FIG. 1 illustrates an example in which a robot travels in a distribution warehouse while capturing images, to perform a method for mapping location codes;

FIG. 2 schematically illustrates a configuration in which an information processing system is communicatively connected to a plurality of robots;

FIG. 3 illustrates an example of performing image pre-processing;

FIG. 4 illustrates an example of detecting a character format location code based on an image;

FIG. 5 illustrates an example of estimating location information of a location code;

FIG. 6 illustrates examples of missing values and abnormal values;

FIG. 7 illustrates an example of removing abnormal values;

FIG. 8 illustrates an example of removing abnormal values or compensating missing values;

FIG. 9 illustrates an example of a location map;

FIG. 10 illustrates an example of determining a picking location;

FIG. 11 is a flowchart illustrating an example of a method for mapping location codes;

FIG. 12 is a flowchart illustrating an example of a method for mapping location codes;

FIG. 13 illustrates an example of a driving robot equipped with a cell directing apparatus;

FIG. 14 is a block diagram of an internal configuration of a driving robot equipped with a cell directing apparatus;

FIG. 15 is a block diagram of internal configurations of a driving robot and a cell directing apparatus;

FIG. 16 illustrates an example in which a driving robot equipped with a cell directing apparatus moves to a picking location to assist the user in picking a target object;

FIG. 17 illustrates an example of a method for calculating local location information of a cell and calculating a rotation angle of an actuator based on the location information of the cell;

FIG. 18 illustrates an example of a cell directing apparatus;

FIG. 19 illustrates an example in which a driving robot equipped with a cell directing apparatus assists a user in picking an object; and

FIG. 20 is a flowchart illustrating an example of a method for assisting a user in picking an object.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, in which case the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly displays the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), etc. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor can read information from and/or write information to the memory. The memory integrated with the processor is in electronic communication with the processor.

In the present disclosure, a “system” may refer to at least one of a server device and a cloud device, but not limited thereto. For example, the system may include one or more server devices. In another example, the system may include one or more cloud devices. In still another example, the system may include both the server device and the cloud device operated in conjunction with each other.

In the present disclosure, a “display” may refer to any display device associated with a driving robot, a cell directing apparatus, and/or an information processing system, and, for example, it may refer to any display device that is controlled by the driving robot, the cell directing apparatus and/or the information processing system or that is capable of displaying any information/data provided from the driving robot, the cell directing apparatus and/or the information processing system.

In the present disclosure, “each of a plurality of A” may refer to each of all components included in the plurality of A, or may refer to each of some of the components included in a plurality of A.

In the present disclosure, terms such as first, second, etc. are only used to distinguish certain components from other components, and the nature, sequence, order, etc. of the components are not limited by the terms.

In the present disclosure, if a certain component is stated as being “connected”, “combined” or “coupled” to another component, it is to be understood that there may be yet another intervening component “connected”, “combined” or “coupled” between the two components, although the two components may also be directly connected, combined or coupled to each other.

In the present disclosure, as used in the following examples, “comprise” and/or “comprising” does not foreclose the presence or addition of one or more other elements, steps, operations, and/or devices in addition to the recited elements, steps, operations, or devices.

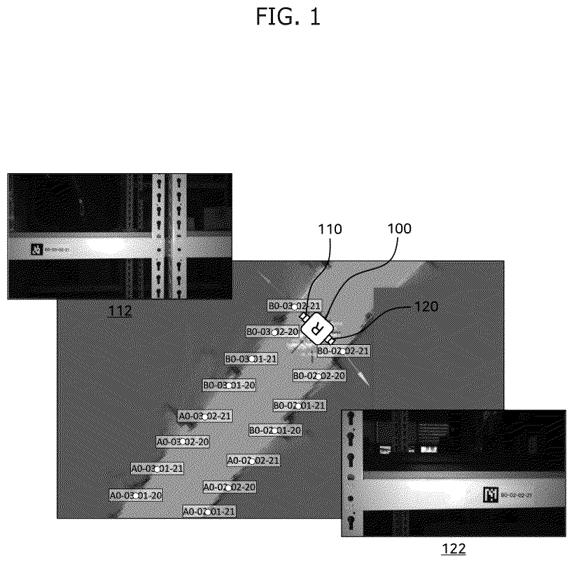

FIG. 1 illustrates an example in which a robot 100 travels in a distribution warehouse while capturing images 112 and 122, to perform a method for mapping location codes. The robot 100 (e.g., a robot for map mapping) may travel through a passage in a distribution warehouse, and a plurality of monocular cameras 110 and 120 mounted on the robot 100 may capture the images 112 and 122 including location codes.

For example, while the robot 100 travels through the passage in the distribution warehouse, a first monocular camera 110 may capture a plurality of first images 112 (e.g., left images) at each of a plurality of locations, and a second monocular camera 120 may capture a plurality of second images 122 (e.g., right images) at the same locations as the locations where each of the plurality of first images 112 is captured. The plurality of first images 112 and/or the plurality of second images 122 may include a plurality of location codes.

The location code may refer to a character format code which is designated in association with a specific place (e.g., a specific passage, a specific rack, a specific cell, etc.) in a distribution warehouse etc. where an object is stored so as to specify the specific place. For example, the location code may be a character format code attached to a rack to distinguish from one another the partitioned areas (e.g., a plurality of cells) of the rack in the distribution warehouse.

The plurality of images 112 and 122 captured by the first and second monocular cameras 110 and 120, and location information on the location where each image is captured may be transmitted to an information processing system, and the information processing system may estimate location information of each of the plurality of location codes included in the image based on the received plurality of images 112 and 122 and location information on the location where each image is captured. Additionally, a location map may be generated using the estimated location information of each of a plurality of location codes. The generated location map may be stored in the robot 100 or a server, and the robot 100 or a separate robot (e.g., a driving robot to assist a user in picking an object, a driving robot equipped with a cell directing apparatus to be described below, etc.) may use the location map to perform logistics-related tasks or assist a worker in performing his or her tasks.

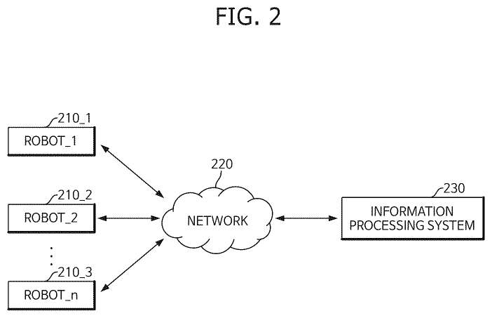

FIG. 2 is a schematic diagram illustrating a configuration in which an information processing system 230 is communicatively connected to a plurality of robots 210_1, 210_2, and 210_3. As illustrated, the plurality of robots 210_1, 210_2, and 210_3 may be connected to the information processing system 230 through a network 220.

The information processing system 230 may include one or more server devices and/or databases, or one or more distributed computing devices and/or distributed databases based on cloud computing services, which can store, provide and execute computer-executable programs (e.g., downloadable applications) and data associated with the logistics management.

The plurality of robots 210_1, 210_2, and 210_3 may communicate with the information processing system 230 through the network 220. The network 220 may be configured to enable communication between the plurality of robots 210_1, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication may include a communication method using a communication network (e.g., mobile communication network, wired Internet, wireless Internet, broadcasting network, satellite network, etc.) that may be included in the network 220 as well as short-range wireless communication between the robots 210_1, 210_2, and 210_3, but aspects are not limited thereto. FIG. 2 illustrates that three robots 210_1, 210_2, and 210_3 are in communication with the information processing system 230 through the network 220, but aspects are not limited thereto, and a different number of robots may be configured to be in communication with the information processing system 230 through the network 220.

The information processing system 230 may receive a first image captured at a specific location from a first monocular camera mounted on a robot 210 (e.g., a map generating robot), and may receive a second image captured at the specific location from a second monocular camera mounted on the robot 210. In addition, the information processing system 230 may receive information on a specific location (that is, a location where the first image and the second image are captured). The information processing system 230 may detect one or more character format location codes based on at least one of the first image and the second image. The information processing system 230 may estimate the information on location of each of the at least one detected location code.

Additionally, the robot 210 (e.g., a picking assistant robot, a driving robot equipped with a cell directing apparatus described below, etc.) may receive, from the information processing system 230, the location information of a cell having a target object to be picked placed therein. The location information of the cell may include information on a location code associated with the cell. The robot 210 may move to a picking location for assisting in picking a target object. The picking location may be determined based on a location of a location code associated with the cell having the target object to be picked placed therein. The robot 210 may assist a user in picking an object by pointing to a cell having the target object placed therein with spotlight illumination. Additionally, the robot 210 may receive a user input indicating completion of picking the target object and transmit the received input to the information processing system 230. The information processing system 230 may transmit the location of the cell having the next target object to be picked placed therein to the robot 210 to assist in picking the next target object to be picked, or transmit information indicating the completion of picking to the robot 210 to end the picking assistance operation.

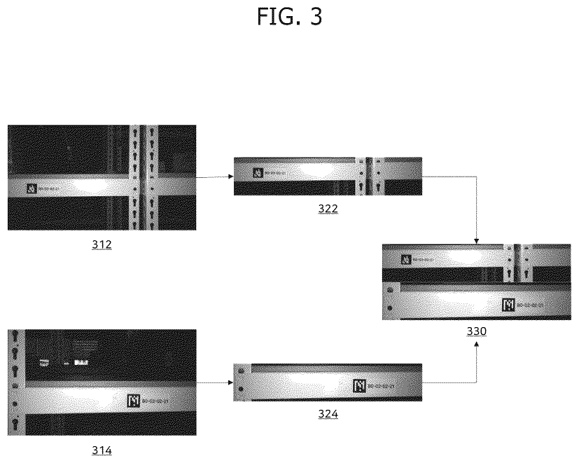

FIG. 3 illustrates an example of performing image pre-processing. The information processing system may receive a plurality of first images captured at a plurality of locations by the first monocular camera mounted on the robot, and receive a plurality of second images captured at the plurality of locations by the second monocular camera. In an example, the character format location codes may be detected from the received images using OCR. Meanwhile, the image pre-processing may be performed before performing the OCR operation on the received images.

The information processing system may receive a first image 312 captured at a first location by the first monocular camera mounted on the robot and a second image 314 captured at the first location by the second monocular camera mounted on the robot, and perform the image pre-processing on the images.

If the OCR operation is performed on a plurality of original images, it requires a large amount of computations and accordingly, resources may not be efficiently used. To address this problem, the information processing system may crop the first image 312 and the second image 314 so that areas associated with the location code of the first image 312 and the second image 314 remain, and merge (e.g., stitch) the cropped first image 322 and the cropped second image 324 into a single image 330.

In a specific example of cropping the image, the information processing system may perform image segmentation on the first image 312 and the second image 314 so as to extract the areas associated with the location codes (e.g., areas including the character format location codes) from the images 312 and 314, and crop the first image 312 and the second image 314 so that the extracted areas remain.

In another specific example of cropping the image, the information processing system may crop the first image 312 and the second image 314 using physical information of the rack so that the areas associated with the location code remain. For example, the information processing system may calculate a minimum height and a maximum height of an area in the images 312 and 314 where the location code may be included, using height information of an area of the rack to which the location code is attached, posture information of the camera that captured the images 312 and 314, etc. and crop the first image 312 and the second image 314 such that the area between the minimum height and the maximum height remains.

Meanwhile, since the robot captures an image while traveling in the distribution warehouse, motion blur may appear due to the movement of the robot. Additionally or alternatively, noise may be included in the image according to the illumination environment of the distribution warehouse etc. To address this problem, the information processing system during the pre-processing may remove the noise from the images 312, 314, 322, 324, and 330. For example, image deblurring, image sharpening, image binarization, and/or equalization, etc. using a machine learning model (e.g., Generative Adversarial Networks (GANs)) may be performed on the images 312, 314, 322, 324, and 330, but the scope of the present disclosure is not limited thereto, and the noise of the image may be removed by various filtering methods.

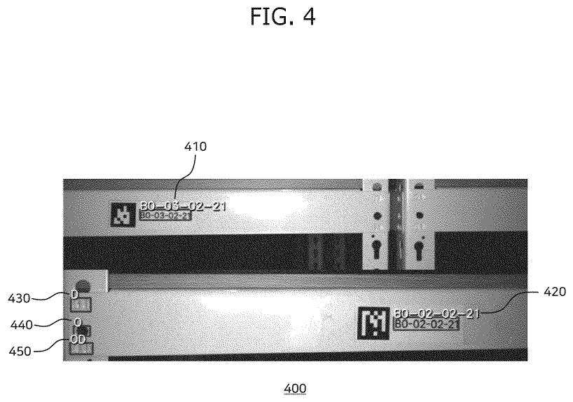

FIG. 4 illustrates an example of detecting character format location codes 410 and 420 based on an image 400. The information processing system may detect one or more location codes 410 and 420 included in the image 400 using OCR. In an example in which the image pre-processing is performed, the image 400 may refer to a pre-processed image.

For example, first, the information processing system may detect character information included in the image 400 using OCR. The OCR (optical character recognition) may refer to a technique of extracting character information included in an image, etc. If OCR operation is performed on the image 400, the character information may be erroneously extracted from a part that does not contain character, or character other than the location codes may be extracted together.

In order to filter these errors 430, 440, 450 and detect only the location codes 410 and 420, the information processing system may detect one or more location codes 410 and 420 from among the detected character information 410, 420, 430, 440, or 450 based on the location code pattern. For example, in the example shown in FIG. 4, the information processing system may compare the location code pattern ‘XX-XX-XX-XX’ (where, ‘X’ represents one character) with the detected character information 410, 420, 430, 440, and 450, respectively, and select only character information matching the location code pattern, to detect a first location code ‘B0-03-02-21’ 410 and a second location code T0-02-02-21′ 420 from the image 400.

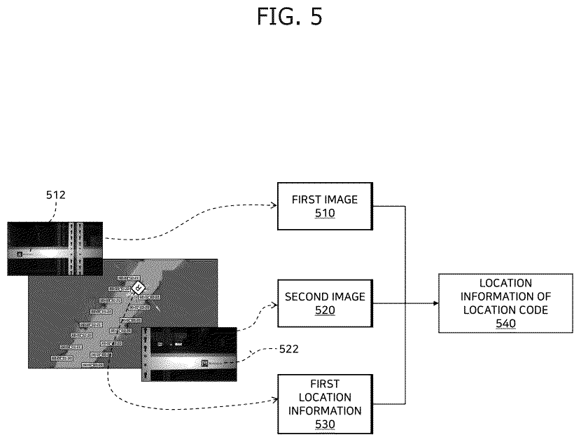

FIG. 5 illustrates an example of estimating location information 540 of a location code. The information processing system may estimate the location information 540 of location codes 512 and 522 based on a first image 510, a second image 520, and a first location information 530.

The first location information 530 may be information on the location that the robot (or camera) was in at the time the first image 510 and the second image 520 were captured, and the location information may be a concept including posture information. A robot equipped with a monocular camera that captures the first image and the second image (e.g., a map generating robot) may be a robot capable of localization, and the first location information 530 may be location information estimated by the robot.

The information processing system may first estimate 3D location information of each of the location codes 512 and 522 based on the first image 510, the second image 520 and the first location information 530. For example, the information processing system may estimate the 3D location information of the first location code 512 by using the physical information of the subject captured in the first image 510 (e.g., size information of the cell captured in the first image 510) and a focal length of the first monocular camera that captured the first image 510. In addition, the information processing system may estimate the 3D location information of the second location code 522 by using the physical information of the subject captured in the second image 520 and the focal length of the second monocular camera that captured the second image 520.

As another example, the information processing system may estimate the 3D location information of each of the one or more location codes 512 and 522 from a plurality of images using triangulation. Specifically, the information processing system may estimate the 3D location information of the first location code 512 or the second location code 522 based on the first image 510 and the second image 520 using triangulation.

As another specific example, the information processing system may estimate the 3D location information of the first location code 512 using triangulation, based on the first image 510 including the first location code 512 and one or more third images (not shown) including the first location code 512 captured at a location different from the first image 510. Similarly, the information processing system may estimate the 3D location information of the second location code 522 using triangulation, based on the second image 520 including the second location code 522 and one or more fourth images (not shown) including the second location code 522 captured at a location different from the second image 520.

The 3D location information estimated in the examples described above may be location information based on the robot. In this case, the information processing system may convert the 3D location information based on robot into global location information indicating a location in the global coordinate system.

As described above, a location map may be generated using the estimated location information 540 of the location code.

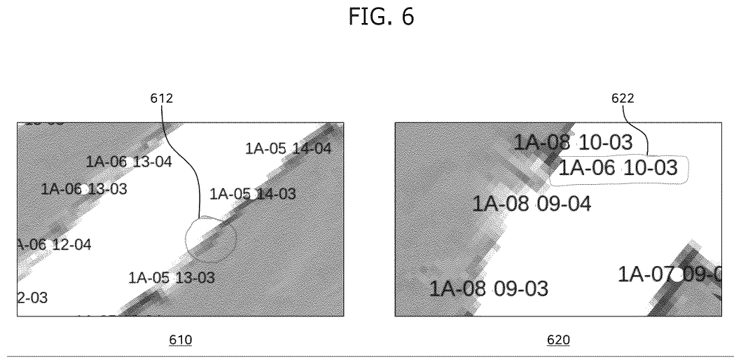

FIG. 6 illustrates examples of a missing value 612 and an abnormal value 622. The location map may be generated using the location information of each of a plurality of location codes estimated by the method described above. Meanwhile, inaccurate information may be estimated in the process of estimating the location information of the location code. For example, there may be an error in the location information estimated by the robot. As another example, in the process of detecting the character information using OCR, there may be an error such as erroneously recognizing similarly shaped characters (e.g., 6, 8, etc.) Due to the errors described above, the missing value 612 or the abnormal value 622 may be present in the generated location map.

FIG. 6 shows two examples 610 and 620 of the location maps generated using the location information of each of a plurality of location codes estimated according to various examples of the present disclosure.

In the first example 610, it may be estimated that the location code “1A-05-13-0” is missing in the displayed location 612 in view of the tendency in which the respective location codes are arranged. The information processing system may compensate for this missing value 612 based on the tendency in which the location codes are arranged.

In addition, in the second example 620, it is estimated that the location code “1A-06-10-03” 622 is not located on the rack, and may be estimated to be an abnormal value in view of the tendency in which the surrounding location codes are arranged. The information processing system may remove this abnormal value 622 based on the tendency in which location codes are arranged.

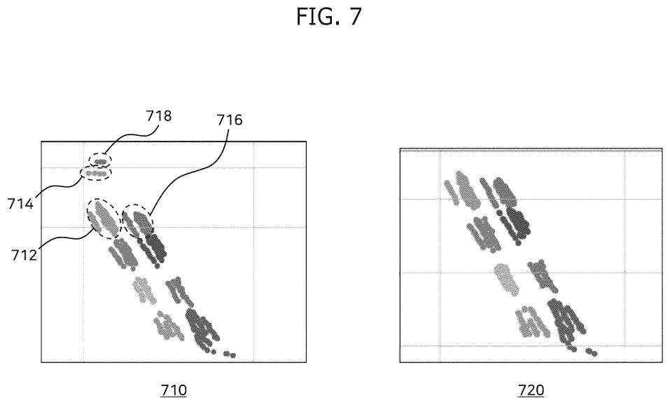

FIG. 7 illustrates an example of removing abnormal values 714 and 718. The information processing system may remove an abnormal value from the estimated information on location of a plurality of location codes. For example, the information processing system may remove the abnormal value by clustering locations where images having a plurality of location codes detected therein are captured. The method of clustering may include Density-Based Spatial Clustering of Application with Noise (DBSCAN) and Euclidean distance-based clustering methods (e.g., K-means, etc.), but aspects are not limited thereto, and various methods may be used. As another example, the information processing system may remove the abnormal value using a Random Sample Consensus (RANSAC) algorithm.

A first example 710 shown in FIG. 7 is an example in which locations where images having a plurality of location codes detected therein are captured are displayed. Dots of the same color may represent the locations where the images having the same location code detected therein are captured. Considering the tendency of the data, a first set of locations 712 where the images having the first location code detected therein are captured, and a second set of locations 716 where the images having the second location code detected therein are captured may be estimated to be error-free.

On the other hand, a third set of locations 714 where the images having the first location code detected therein are captured, and a fourth set of locations 718 where the images having the second location code detected therein are captured are far from the first set of locations 712 and the second set of locations 716, respectively, and may be determined to be abnormal values or noise by the clustering or the RANSAC algorithm. The information processing system may remove the abnormal values by removing the data 714 and 718 determined to be abnormal values or noise by the clustering or algorithms FIG. 7 shows a second example 720 in which the abnormal values 714 and 718 are removed from the first example 710.

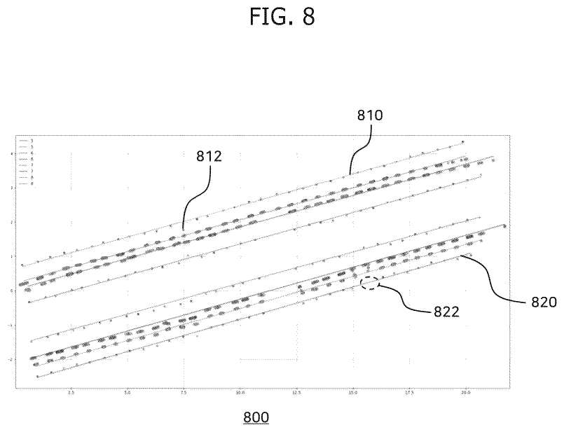

FIG. 8 illustrates an example of removing an abnormal value 812 or compensating a missing value 822. The location code may be a character format code attached to a rack to distinguish from one another partitioned areas (e.g., a plurality of cells) of the rack in the distribution warehouse. In this case, it may be assumed that those of the location codes that are attached to the same rack will be located on the same straight line. In addition, since the cells are generally arranged according to a certain rule (e.g., at regular intervals) on the rack, it may be assumed that the location codes attached to each cell of the same rack are arranged according to a certain rule. The abnormal values may be removed or missing values may be compensated using this assumption.

For example, first, the information processing system may approximate a linear function representing a straight line based on the information on location of each of the location codes that are estimated to be on the same straight line. The approximated linear function or the straight line may each represent a rack or a passage where the rack is arranged. An example 800 of FIG. 8 shows an example of approximating a first linear function 810 associated with the first set of location codes and a second linear function 820 associated with the second set of location codes.

The information processing system may remove an abnormal value based on the approximated linear function and the information on location of the location codes. For example, the information processing system may remove the abnormal value by removing the information on location of a location code of the location codes, if the location code of the location codes has the residual from the linear function exceeding a predefined threshold. In the illustrated example, the information processing system may treat the first data 812 having the residual from the first linear function 810 exceeding the predefined threshold value as an abnormal value and remove the same.

Additionally or alternatively, the information processing system may compensate for a missing value based on the linear function and the information on location of each location code. In the illustrated example, the information processing system may perceive that data is missing in the first location 822 above the second linear function 820 based on the arrangement rule of the second set of location codes, and compensate for the missing value.

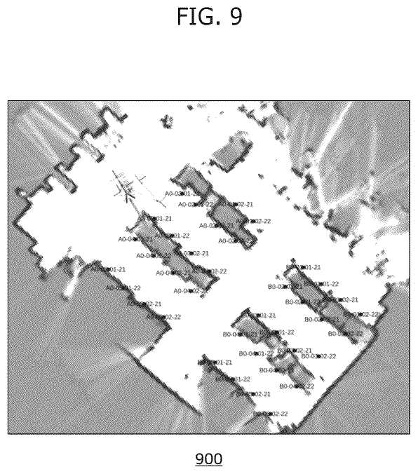

FIG. 9 illustrates an example of a location map. FIG. 9 shows an example of a location map 900 generated based on the estimated information on location of each of a plurality of location codes (information on location of each of a plurality of location codes removed of the abnormal value, and information on the compensated missing value). The location map 900 may include information on location of each of a plurality of location codes in the distribution warehouse. The robot may receive the location map 900, store the same, and use the stored location map 900 to perform tasks related to logistics management or assist a worker in performing his or her tasks.

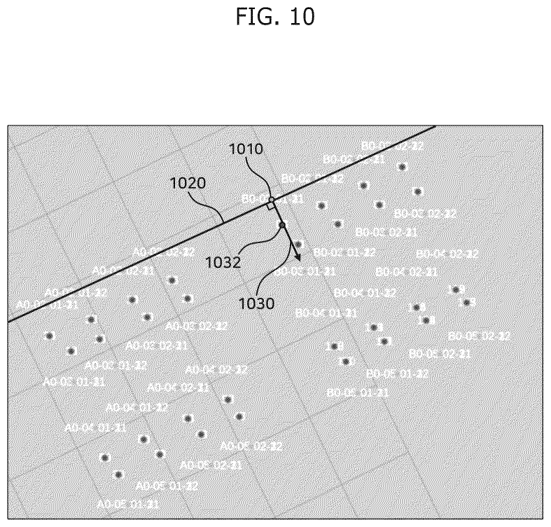

FIG. 10 illustrates an example of determining a picking location 1032. The information processing system may determine a picking location (in pink) associated with each of a plurality of location codes based on the estimated information (in yellow) on location of each of a plurality of location codes.

For example, the information processing system may approximate a linear function 1020 associated with a third set of location codes based on information on location of each of the third set of location codes estimated to be on the same straight line as a first location code 1010. The information processing system may determine picking location 1032 present on a normal 1030 of the linear function 1020 passing through the location of the first location code 1010. In this way, the picking location associated with each of the plurality of location codes may be determined. The determined picking location 1032 may be used for a robot to perform picking tasks in the distribution warehouse or to assist a worker in performing picking tasks.

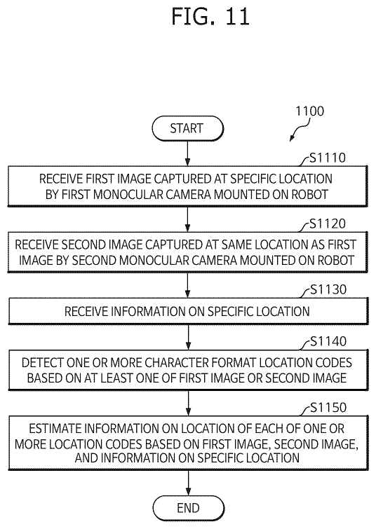

FIG. 11 is a flowchart illustrating an example of a method 1100 for mapping location codes. The method 1100 may be initiated by a processor (e.g., one or more processors of the information processing system) that receives a first image captured at a specific location with a first monocular camera mounted on the robot, at S1110, and receives a second image captured at the specific location with a second monocular camera mounted on the robot, at S1120. The processor may receive information on a specific location, at 51130. That is, the processor may receive the information on a location where the first image and the second image are captured. The robot may be a robot capable of localization, and the information on a specific location may be the location information estimated by the robot.

The processor may detect one or more character format location codes based on at least one of the first image and the second image, at S1140. The location code may be a code attached to the rack to distinguish from one another the partitioned areas of the rack. The processor may detect one or more location codes included in at least one of the first image and the second image by using the Optical Character Recognition (OCR). For example, the processor may detect character information included in at least one of the first image and the second image by using OCR. Based on the location code pattern, one or more location codes may be detected from the detected character information.

The processor may pre-process the first image and the second image before detecting the location code from the image by using OCR. For example, the processor may crop the first image and the second image such that areas in the first image and the second image that are associated with the location code remain. Additionally, the processor may merge the cropped first image and the cropped second image. Additionally or alternatively, the processor during the pre-processing may remove noise from the first image and the second image. The processor may detect the location code based on the pre-processed image.

As a specific example of cropping the first image and the second image, the processor may extract areas associated with the location code by performing image segmentation on the first image and the second image, and crop the first image and the second image such that the areas associated with the location code remain. As another specific example of cropping the first image and the second image, the processor may crop the first image and the second image using physical information of the rack such that areas in the first image and the second image that is associated with the one or more location codes remain.

The processor may estimate information on location of each of one or more location codes based on the first image, the second image, and the information on the specific location, at S1150. For example, the processor may estimate 3D location information based on robot for each of the one or more location codes, based on the first image, the second image, and the information on the specific location. The processor may convert the 3D location information of each of the one or more location codes into global location information indicating the location of the one or more location codes in the global coordinate system.

As a specific example of estimating the 3D location information of one or more location codes, the processor may estimate the 3D location information of each of the one or more location codes by using the physical information of a subject captured in the first image or the second image and a focal length of the first monocular camera or the second monocular camera. As another specific example of estimating the 3D location information of one or more location codes, the processor may estimate the 3D location information of each of the one or more location codes using triangulation. A location map may be generated using the location information of the location code estimated in this way.

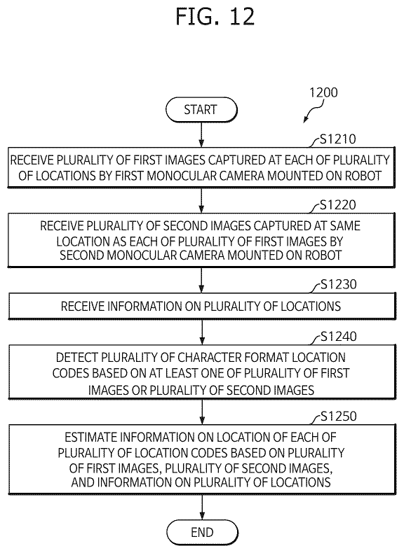

FIG. 12 is a flowchart illustrating an example of a method 1200 for mapping location codes. The method 1200 may be initiated by a processor (e.g., one or more processors of the information processing system) that receives a plurality of first images captured at a plurality of locations by a first monocular camera mounted on the robot, at S1210, and receives a plurality of second images captured at the plurality of locations by a second monocular camera mounted on the robot, at S1220. The processor may receive information on a plurality of locations where the plurality of first images and the plurality of second images are captured, at S1230.

The processor may detect a plurality of character format location codes based on at least one of the plurality of first images and the plurality of second images, at S1240. The processor may estimate information on location of each of a plurality of location codes based on the plurality of first images, the plurality of second images, and information on location of each of the plurality of locations, at S1250.

Additionally, the processor may remove an abnormal value in the estimated information on location of each of the plurality of location codes. For example, the processor may remove the abnormal value by clustering the locations where the images having a plurality of location codes detected therein are captured. Additionally or alternatively, the processor may approximate a linear function associated with the first set of location codes based on the information on location of each of the first set of location codes estimated to be on the same straight line. The processor may remove the abnormal value by removing the information on location of a location code of the first set of location codes, if the location code of the first set of location codes has a residual from the linear function exceeding a predefined threshold.

Additionally or alternatively, the processor may compensate for a missing value in the estimated information on location of each of the plurality of location codes. For example, based on the information on location of each of the second set of location codes estimated to be on the same straight line, the processor may approximate a linear function associated with the second set of location codes. The processor may compensate for the missing value based on the information on location of each of the second set of location codes and the linear function. A location map may be generated based on the information on location of each of a plurality of location codes removed of the abnormal value, and information on the compensated missing value.

Additionally, the processor may determine a picking location associated with each of the plurality of location codes based on the estimated information on location of each of the plurality of location codes. For example, based on the information on location of each of the third set of location codes estimated to be on the same straight line as a specific location code, the processor may approximate a linear function associated with the third set of location codes. The processor may determine a picking location present on a normal of the linear function passing through the location of the specific location code.

The flowcharts of FIGS. 11 and 12 and the description provided above are merely one example of the present disclosure, and aspects may be implemented differently in various examples. For example, some steps of operation may be added or deleted, or the order of each step may be changed.

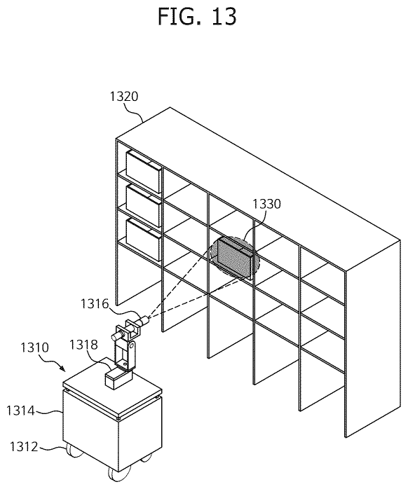

FIG. 13 illustrates an example of a driving robot 1310 equipped with a cell directing apparatus. The driving robot 1310 equipped with the cell directing apparatus may assist the user (collaborator) in picking. The term “picking” as used herein may refer to an operation of taking out or bringing a target object from a place in the distribution warehouse where the target object is stored, and the term “user” may refer to a worker who performs the picking tasks. For example, the driving robot 1310 may move to a picking location near a rack 1320 including a cell 1330 having target objects to be picked placed therein. The picking location may be a picking location associated with the location code of the cell 1330. The driving robot 1310 may point to the cell 1330 having the target objects to be picked placed therein with a spotlight illumination 1316 so as to allow the user to intuitively aware of the location of the target objects, thereby improving the work efficiency of the user.

The driving robot 1310 equipped with the cell directing apparatus may include a driving unit 1312, a loading unit 1314, the spotlight illumination 1316, and an actuator 1318.

The driving unit 1312 may be configured to move the driving robot 1310 along a driving path, etc. The driving unit 1312 may include wheels to which driving power is supplied and/or wheels to which driving power is not supplied. The control unit may control the driving unit 1312 such that the driving robot 1310 moves to a picking location near the rack 1320.

The loading unit 1314 may be configured to load or store objects picked by the user. For example, the user may take out a target object from the cell 1330 having the target object placed therein and load the target object into the loading unit 1314. The loading unit 1314 may be configured in various shapes and sizes as needed.

The spotlight illumination 1316 is a light that intensively illuminates light on a certain area to highlight the area, and may be configured to illuminate the cell 1330 having the target object placed therein to visually guide the user to the location of the cell 1330. The control unit may control the spotlight illumination 1316 such that the spotlight illumination 1316 is on (the light is turned on) or off (the light is turned off).

The actuator 1318 may be configured to adjust a pointing direction of the spotlight illumination 1316. For example, the actuator 1318 may be configured to be directly or indirectly connected to the spotlight illumination 1316 such that the spotlight illumination 1316 points to a specific location according to the actuation of the actuator 1318. The control unit may control the operation of the actuator 1318 to adjust the pointing direction of the spotlight illumination 1316. Specific examples of the configuration and operation of the actuator 1318 will be described below in detail with reference to FIG. 7.

The driving robot 1310 equipped with the cell directing apparatus illustrated in FIG. 13 is merely an example for implementing the present disclosure, and the scope of the present disclosure is not limited thereto and may be implemented in various ways. For example, although a driving robot that moves using wheels is illustrated as an example in FIG. 13, a driving robot including a driving unit of various types, such as a drone or a biped walking robot, may be included in the present disclosure. As another example, the driving robot equipped with the cell directing apparatus may not include the loading unit 1314, and a device (e.g., a logistics transport robot) for loading and transporting objects picked by the user may be configured separately from the driving robot 1310. As another example, instead of integrally configuring the driving robot 1310 equipped with the cell directing apparatus, the cell directing apparatus including the spotlight illumination 1316 and the actuator 1318 and the driving robot including the driving unit 1312 may be configured as separate devices, and the devices may be combined and used to assist picking.

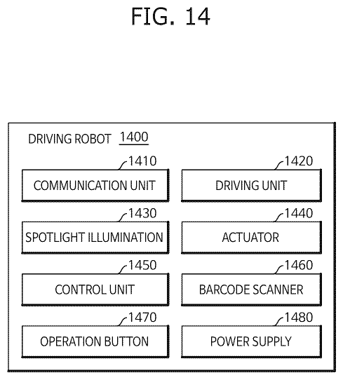

FIG. 14 is a block diagram illustrating an internal configuration of a driving robot 1410 equipped with a cell directing apparatus. As illustrated, the driving robot 1410 may include a communication unit 1410, a driving unit 1420, a spotlight illumination 1430, an actuator 1440, a control unit 1450, a barcode scanner 1460, an operation button 1470, and a power supply unit 1480.

The communication unit 1410 may provide a configuration or function for enabling communication between the driving robot 1410 and the information processing system through a network, and may provide a configuration or function for enabling communication between the driving robot 1410 and another driving robot or another device/system (e.g., a separate cloud system, etc.) For example, a request or data generated by the control unit 1450 of the driving robot 1410 (e.g., a request for location information of a cell having a target object placed therein, etc.) may be transmitted to the information processing system through a network under the control of the communication unit 1410. Conversely, a control signal or command provided by the information processing system may be received by the driving robot 1410 through the communication unit 1410 of the driving robot 1410 through a network. For example, the driving robot 1410 may receive the location information, etc. of a cell having a target object placed therein from the information processing system through the communication unit 1410.

The driving unit 1420 may be configured to move the driving robot 1410 along a driving path, etc. The driving unit 1420 may include wheels to which driving power is supplied and/or wheels to which power is not supplied. The driving unit 1420 may control the driving robot 1410 under the control of the control unit 1450 so that the driving robot 210 moves to a specific location (e.g., picking tasks, etc.)

The spotlight illumination 1430 may be a light that intensively illuminates light on a partial area to highlight that area. The pointing direction of the spotlight illumination 1430 may be changed according to driving of the actuator 1440 so that the cell having the target object placed therein is illuminated. The spotlight illumination 1430 may be configured to be changed between on state (where light is turned on) and off state (where light is turned off) under the control of the control unit 1450.

Under the control of the control unit 1450, the actuator 1440 may be driven to adjust the pointing direction of the spotlight illumination 1430. For example, the actuator 1440 may be directly or indirectly coupled to the spotlight illumination 1430 and controlled such that the spotlight illumination 1430 points to a specific location according to the actuation of the actuator 1440.

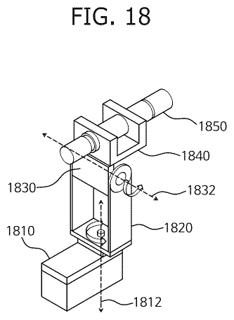

The driving robot 1410 may include a plurality of actuators. For example, the actuator 1440 may include a first actuator configured to be rotated about a first rotation axis, and a second actuator configured to be rotated about a second rotation axis different from the first rotation axis. In this case, the spotlight illumination 1430 may point to any direction in space according to the rotation of the first actuator and the second actuator. Specific examples of the configuration and operation of the actuator 1440 will be described below in detail with reference to FIG. 18.

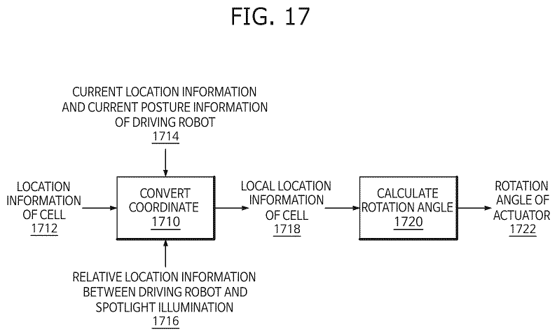

As described above, the control unit 1450 may control the driving unit 1420, the spotlight illumination 1430, the actuator 1440, the barcode scanner 1460, and the operation button 1470. In addition, the control unit 1450 may be configured to process the commands of the program for logistics management by performing basic arithmetic, logic, and input and output computations. For example, the control unit 1450 may calculate local location information of a cell by performing coordinate conversion based on the location information of the cell received through the communication unit 1410. As another example, the control unit 1450 may calculate a rotation angle of the actuator 1440 such that the pointing direction of the spotlight illumination 1430 corresponds to the location of the cell. A method for the control unit 1450 to calculate the local location information of the cell or the rotation angle of the actuator 1440 will be described below in detail with reference to FIG. 17.

The barcode scanner 1460 may be configured to scan a barcode attached to the target object, and the operation button 1470 may include a physical operation button or a virtual button (e.g., a user interface element) displayed on a display or touch screen. The control unit 1450 may receive barcode data associated with the target object through the barcode scanner 1460 and/or receive a user input through the operation button 1470, and perform appropriate process accordingly. For example, the control unit 1450 may check, through the barcode data received from the barcode scanner 1460, whether or not the target object is properly picked, and receive, through the operation button 1470, a user input indicating the completion of picking the target object, and provide, through the communication unit 1410 and the network, the received input to the information processing system.

The power supply unit 1480 may supply energy to the driving robot 1410 or to at least one internal component in the driving robot 1410 to operate the same. For example, the power supply unit 1480 may include a rechargeable battery. Additionally or alternatively, the power supply unit 1480 may be configured to receive power from the outside and deliver the energy to the other components in the driving robot 1410.

The driving robot 1410 may include more components than those illustrated in FIG. 14. Meanwhile, most of the related components may not necessarily require exact illustration. The driving robot 1410 may be implemented such that it may include an input and output device (e.g., a display, a touch screen, etc.) In addition, the driving robot 1410 may further include other components such as a transceiver, a Global Positioning System (GPS) module, a camera, various sensors, a database, and the like. For example, the driving robot 1410 may include components generally included in the driving robots, and may be implemented such that it may further include various components such as, for example, an acceleration sensor, a camera module, various physical buttons, and buttons using a touch panel.

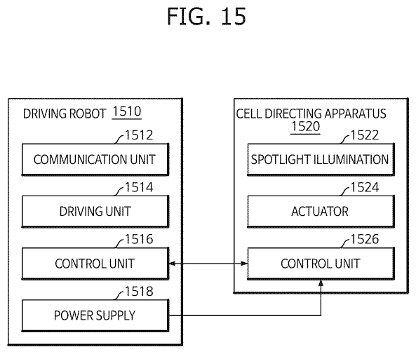

FIG. 15 is a block diagram of the internal configuration of a driving robot 1510 and a cell directing apparatus 1520. The driving robot 1510 including a driving unit 1514, and the cell directing apparatus 1520 including a spotlight illumination 1522 and an actuator 1524 may be configured as separate devices. In this case, the driving robot 1510 and the cell directing apparatus 1520 may be used in combination to assist the user with picking. For example, the driving robot 1510 and the cell directing apparatus 1520 may be connected by wire and used, or may be used while sharing information and/or data with each other through wireless communication. In this case, the producer and the seller of the driving robot 1510 and the cell directing apparatus 1520 may be different.

Even when the driving robot 1510 and the cell directing apparatus 1520 are configured as separate devices, the internal configurations of the driving robot 1510 and the cell directing apparatus 1520 may be applied in the same or similar manner to those of FIG. 14 and the above description. In FIG. 15, the driving robot 1510 and the cell directing apparatus 1520 configured as separate devices from each other will be described mainly with reference to the differences.

The driving robot 1510 may include a communication unit 1512, the driving unit 1514, a control unit 1516, and a power supply unit 1518. Further, the cell directing apparatus 1520 may include the spotlight illumination 1522, the actuator 1524, and a control unit 1526. Additionally, the cell directing apparatus 1520 may further include a communication unit (not illustrated) for communication with an external device and/or the driving robot 1510. The control unit 1526 may be configured to integrally perform the functions of the communication unit.

The power supply unit 1518 of the driving robot may be configured to supply power to at least one internal component of the cell directing apparatus 1520 (e.g., the control unit 1526, the actuator 1524, the spotlight illumination 1522, etc. of the cell directing apparatus). In addition, the control unit 1516 of the driving robot may be configured to control the driving unit 1514 and configured to transmit and receive information, data, commands, etc. to and from the control unit 1526 of the cell directing apparatus.

The control unit 1526 of the cell directing apparatus may be configured to control the spotlight illumination 1522 and the actuator 1524, and configured to transmit and receive information, data, commands, etc. to and from the control unit 1516 of the driving robot.

For example, the control unit 1526 of the cell directing apparatus may control the spotlight illumination 1522 and the actuator 1524 based on the data and/or commands provided from the control unit 1516 of the driving robot. As a specific example, the control unit 1516 of the driving robot may receive location information (coordinate values [x, y, z] in the global coordinate system) of a cell received from the information processing system (e.g., control server) through the communication unit 1512. The control unit 1516 of the driving robot may determine, by the control unit 1526 of the cell directing apparatus, current location information and current posture information of the driving robot (that is, driving robot localization information [x, y, z, r, p, y] in the global coordinate system). The control unit 1516 of the driving robot may calculate the location information of the determined cell, the current location information of the driving robot, the current posture information of the driving robot, and relative location information between the driving robot 1510 and the cell directing apparatus 1520 (for example, if the current location of the driving robot points to the current location of the driving unit 1514, the relative location information [x, y, z] between the driving unit 1514 and the spotlight illumination 1522), and local location information of the cell in the local coordinate system, which is the self-coordinate system of the driving robot (or the self-coordinate system of the cell directing apparatus 1520), based on the current posture information [r, p, y]) of the spotlight illumination. The control unit 1516 of the driving robot may calculate the rotation angle of the actuator 1524 based on the calculated local location information of the cell. The control unit 1516 of the driving robot may transmit the calculated rotation angle of the actuator 1524 to the control unit 1526 of the cell directing apparatus. The control unit 1526 of the cell directing apparatus may control the actuator 1524 so that the actuator 1524 is rotated based on the received rotation angle of the actuator 1524.

As another specific example, instead of receiving the calculated rotation angle from the control unit 1516 of the driving robot, the control unit 1526 of the cell directing apparatus may receive the location information of the cell, and the current location information and the current posture information of the driving robot from the control unit 1516 of the driving robot, and directly calculate the local location information of the cell, the rotation angle of the actuator 1524, etc. In this case, the control unit 1526 of the cell directing apparatus may control the operation of the actuator 1524 based on the directly calculated rotation angle.

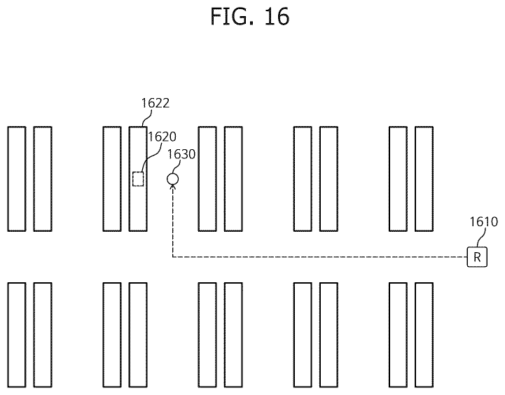

FIG. 16 illustrates an example in which a driving robot 1610 equipped with a cell directing apparatus moves to a picking location 1630 to assist picking a target object 1620. The distribution system may include a plurality of racks storing objects, and each rack may include a plurality of cells. That is, an object (or a plurality of objects) may be stored in each cell in the rack. Each rack, each cell, etc. may be located in a partitioned area and have unique location information (e.g., coordinate values in the global coordinate system). Each cell may be associated with a unique location code.

The driving robot 1610 may receive, from the information processing system, the location information of the cell having the target object 1620 to be picked by the user placed therein. The location information of the cell may include information on a location code associated with the cell.

The driving robot 1610 may move to the determined picking location 1630 along the driving path. For example, the driving robot 1610 may determine the picking location 1630 based on the location information of the cell and move to the picking location 1630 near a rack 1622 that includes a cell having a target object placed therein. Alternatively, instead of determining the picking location 1630, the driving robot 1610 may receive the picking location 1630 from the information processing system. The picking location 1630 may be a location determined by the information processing system based on the location information of the cell (e.g., information on a location code associated with the cell). If the driving robot 1610 moves to the picking location 1630, the user may move to the picking location 1630 along with the driving robot 1610.

The driving robot 1610 arriving at the picking location 1630 may determine its current location information and current posture information. Alternatively, the information processing system may determine the current location information and the current posture information of the driving robot 1610 based on data (e.g., depth image, color image, encoder value of the driving unit, etc.) received from the driving robot 1610, and transmit the information to the driving robot 1610. The driving robot 1610 may point to the cell having the target object 1620 placed therein with the spotlight illumination based on the location information of the cell having the target object placed therein, the current location information of the driving robot 1610, and the current posture information of the driving robot 1610 (if necessary, the relative location information between the driving robot 1610 and the spotlight illumination and the current posture information of the spotlight illumination are further used). The current location information, the current posture information, etc. of the driving robot 1610 may be information estimated by the driving robot 1610 or information received by the information processing system.

Instead of finding the location of the cell by directly checking the location information of the cell, the user may find the cell having the target object 1620 placed therein more quickly and easily by visually checking the cell pointed to by the spotlight illumination. In addition, instead of moving the rack 1622 having the target object placed therein to the vicinity of the location of the cell directing apparatus or the user, by moving the driving robot 1610 equipped with the cell directing apparatus to the vicinity of the target object 1620, it is possible to improve the efficiency of picking operation by utilizing the existing equipment without the need to replace the equipment.

FIG. 17 illustrates an example of a method for calculating a rotation angle 1722 of an actuator based on location information 1712 of a cell. The control unit (e.g., one or more control units of the driving robot, cell directing apparatus, etc.) may control the actuator so that the spotlight points to the cell based on the location information 1712 (coordinate values [x, y, z] in the global coordinate system) of the cell having the target object placed therein, the current location information and the current posture information 1714 of the driving robot (localization information ([x, y, z, r, p, y]) of the driving robot in the global coordinate system), relative location information 1716 ([x, y, z]) between the driving robot and the spotlight illumination, and current posture information ([r, p, y]) of the spotlight illumination.

The control unit may calculate local location information 1718 of the cell by performing coordinate conversion 1710 based on the location information 1712 of the cell and the current location information and the current posture information 1714 of the driving robot. For example, based on the location information 1712 of the cell, which is the coordinate value of the cell in the global coordinate system, and based on the current location information of the driving robot in the global coordinate system and the current posture information 1714 of the driving robot, the control unit may calculate the local location information 1718 of the cell, which indicates the location of the cell having the target object placed therein, in a local coordinate system which is a self-coordinate system of the driving robot.

If the cell directing apparatus and the driving robot are configured as separate devices and the two devices are used in combination, the pointing direction of the spotlight illumination may be changed according to the relative location information of the two devices. Therefore, if the cell directing apparatus and the driving robot are configured as separate devices, the control unit may calculate the local location information 1718 of the cell by additionally considering the relative location information 1716 between the driving robot and the spotlight illumination. The relative location information 1716 between the driving robot and the spotlight illumination may include relative posture information between the driving robot and the spotlight illumination.

The control unit may control the actuator such that the spotlight illumination points to the cell based on the calculated local location information 1718 of the cell. The local location information 1718 of the cell may be a local coordinate value indicating the location of the cell having the target object placed therein in the local coordinate system which is the self-coordinate system of the driving robot (or the cell directing apparatus or the spotlight illumination). For example, the control unit may calculate 1720 the rotation angle 1722 of the actuator based on the local location information 1718 of the cell, and control the actuator to be rotated by the calculated rotation angle 1722. The calculated rotation angle 1722 may be a concept including a rotation direction.

Meanwhile, the rotation angle of the actuator may vary according to the direction currently pointed to by the spotlight illumination. Accordingly, the control unit may calculate the rotation angle 1722 of the actuator by further considering the current posture information of the spotlight.

The cell directing apparatus may include a plurality of actuators having different rotation axes. In this case, the control unit may calculate the rotation angle of each of the plurality of actuators, and control each of the plurality of actuators to be rotated according to the calculated rotation angle. An example of the cell directing apparatus including a plurality of actuators will be described below in detail with reference to FIG. 18.

FIG. 18 illustrates an example of a cell directing apparatus. The cell directing apparatus may include a spotlight illumination 1850 configured to guide to the location of the cell by illuminating the cell having the target object placed therein, and an actuator configured to adjust the pointing direction of the spotlight illumination 1850. The spotlight illumination 1850 may be directly or indirectly connected to the actuator such that the pointing direction may be changed according to driving of the actuator. For example, a specific example of the cell directing apparatus including the actuator and the spotlight illumination 1850 is illustrated in FIG. 18.

The cell directing apparatus may include a first actuator 1810 configured to be rotated about a first rotation axis 1812 and a second actuator 1830 configured to be rotated about a second rotation axis 1832.

The second actuator 1830 may be connected to the first actuator 1810 through a first connection part 1820. Accordingly, it may be configured such that, if the first actuator 1810 is rotated by a first rotation angle about the first rotation axis 1812, the second actuator 1830 is also rotated about the first rotation axis 1812 by the first rotation angle.

In addition, the spotlight illumination 1850 may be connected to the second actuator 1830 through a second connection part 1840. Accordingly, it may be configured such that, as the first actuator 1810 is rotated about the first rotation axis 1812 by a first rotation angle and the second actuator 1830 is rotated about the second rotation axis 1832 by a second rotation angle, the spotlight illumination 1850 is also rotated about the first rotation axis 1812 by the first rotation angle and rotated about the second rotation axis 1832 by the second rotation angle. That is, the spotlight illumination 1850 may be configured such that the pointing direction is adjusted to any direction in space according to the rotation angles of the first actuator 1810 and the second actuator 1830.

The control unit (e.g., the control unit of the driving robot or cell directing apparatus) may calculate the first rotation angle of the first actuator 1810 and the second rotation angle of the second actuator 1830 such that the pointing direction of the spotlight illumination 1850 corresponds to the location of the cell having the target object placed therein. Accordingly, the control unit may control the first actuator 1810 and the second actuator 1830 such that the first actuator 1810 is rotated by the first rotation angle and the second actuator 1830 is rotated by the second rotation angle, thereby controlling the spotlight illumination 1850 to point to the cell having the target object placed therein.

The cell directing apparatus illustrated in FIG. 18 is merely an example, and the scope of the present disclosure is not limited thereto. For example, the cell directing apparatus may be configured such that the spotlight illumination 1850 points to a cell having a target object placed therein according to driving of an actuator rotatable in any direction in space.

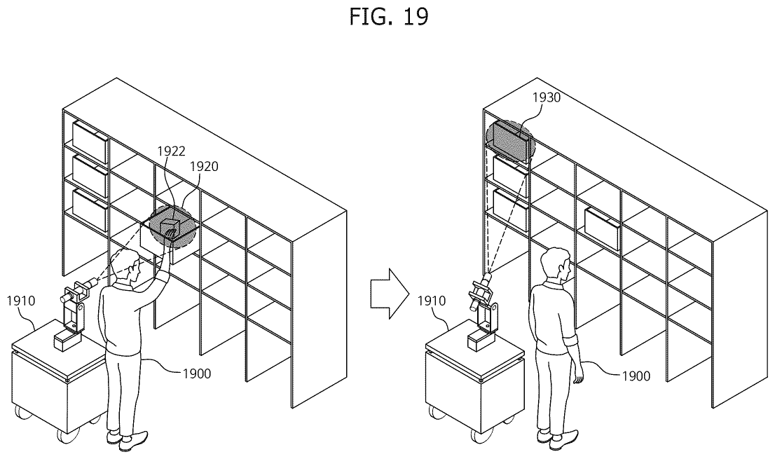

FIG. 19 illustrates an example in which a driving robot 1910 equipped with a cell directing apparatus assists a user 1900 in picking an object. The driving robot 1910 may stop at a picking location and point to a cell 1920 having a target object 1922 placed therein with the spotlight illumination to assist the user 1900 in picking objects. Instead of finding the location of the cell 1920 by directly checking the location information of the cell 1920, the user 1900 is able to find the cell having the target object 1922 placed therein more quickly and easily by checking the cell 1920 pointed to by the spotlight illumination.

In response to receiving barcode data associated with the target object 1922 from a barcode scanner (not illustrated) and/or receiving a user input from an operation button (not illustrated), the driving robot 1910 may complete picking the target object 1922. For example, the user 1900 may take out the target object 1922 and scan a barcode attached to the target object 1922 through the barcode scanner. The user 1900 may enter, through the operation button, an input indicating the completion of picking the target object. The driving robot 1910 may check whether or not the target object 1922 is properly picked, based on the barcode data received through the barcode scanner. In addition, the driving robot 1910 may receive an input indicating the completion of picking the target object 1922 from the user 1900 through the operation button, and transmit information or signal indicating the completion of picking the target object 1922 to the information processing system.

The information processing system may transmit the location of a cell 1930 having the next target object placed therein to the driving robot 1910 so that the driving robot 1910 assists picking the next target object, or may transmit information or signal indicating the completion of the picking operation to the driving robot 1910 so that the driving robot 810 ends the picking assisting operation.

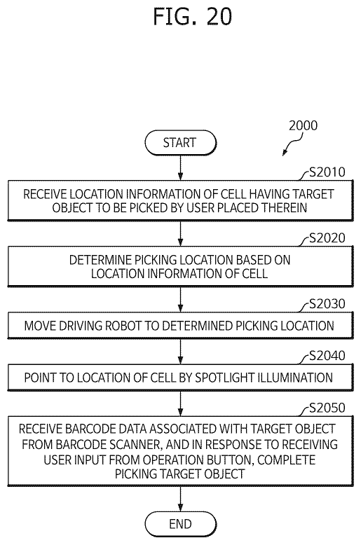

FIG. 20 is a flowchart illustrating an example of a method 2000 for assisting a user in picking objects. The method 2000 may be initiated by a driving robot (e.g., a control unit of the driving robot) equipped with a cell directing apparatus, which receives location information of a cell having a target object to be picked by a user placed therein, at S2010. For example, the driving robot may receive the location information of the cell having the target object placed therein from the information processing system. The cell having the target object placed therein may be associated with a specific location code, and the location information of the cell may include information on the location code associated with the cell.

The driving robot may determine a picking location based on the location information of the cell at S2020, and may move to the determined picking location at S2030. For example, the control unit of the driving robot may determine the picking location based on the location information of the cell, and the driving robot may move to the picking location near the target object through the driving unit. Alternatively, instead of determining the picking location, the driving robot may receive the picking location from an external device capable of communicating with the driving robot and move to the picking location. The picking location may be a location determined by an external device based on the location information of the cell (e.g., information on the location code associated with the cell).

The driving robot may cause the spotlight illumination to point to the location of the cell having the target object placed therein, at S2040. To this end, the driving robot may control the actuator such that the spotlight illumination points to the location of the cell. In addition, the driving robot may control the spotlight illumination such that the spotlight illumination is changed to on state. For example, the actuator may include a first actuator configured to be rotated about a first rotation axis and a second actuator configured to be rotated about a second rotation axis. The driving robot may control the first actuator and the second actuator such that the first actuator is rotated about the first rotation axis by a first rotation angle and the second actuator is rotated about the second rotation axis by a second rotation angle. Accordingly, the pointing direction of the spotlight illumination may be controlled to correspond to the location of the cell.

The driving robot may receive barcode data associated with the target object from the barcode scanner and complete picking the target object in response to receiving a user input from the operation button, at S2050. For example, the user may take out the target object from the cell pointed to by the spotlight illumination and scan a barcode attached to the target object through the barcode scanner. The user may enter, through the operation button, an input indicating the completion of picking the target object. Based on the barcode data received through the barcode scanner, the driving robot may check whether or not the target object is properly picked, and in response to receiving an input indicating the completion of picking the target object from the user through the operation button, transmit, to the information processing system, information or signal indicating the completion of picking the target object. The information processing system may transmit the location of the cell having the next target object placed therein to the driving robot so that the driving robot assists picking the next target object, or transmit information or signal indicating the completion of picking operation to the driving robot so that the driving robot ends the picking assisting operation.

The method for mapping location codes may include receiving, by a processor, a first image captured at a first location by a monocular camera mounted on a robot, and receiving a second image captured at a second location by a monocular camera. Additionally, the method may include receiving, by the processor, information on a first location and information on a second location, and detecting one or more character format location codes based on the first image and the second image. Additionally, the method may include estimating, by the processor, information on location of each of the one or more location codes based on the first image, the second image, the information on the first location, and the information on the second location. The method for mapping location codes may include receiving, by the processor, a plurality of images captured at each of a plurality of locations by a monocular camera mounted on a robot, and receiving information on the plurality of locations. Additionally, the method may include detecting, by the processor, a plurality of character format location codes based on at least two of the plurality of images, and estimating information on location of each of the plurality of location codes based on at least two of the plurality of images and information on each of the plurality of locations.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessed by a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor such that the processor may read or write information from or to the storage medium. Alternatively, the storage medium may be incorporated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

1. A method performed by one or more processors, the method comprising:
receiving a first image captured, at a specific location, by a first monocular camera mounted on a robot;
receiving a second image captured, at the specific location, by a second monocular camera mounted on the robot;
receiving information indicating the specific location;
detecting, based on at least one of the first image or the second image, one or more location codes; and
estimating a location of each location code of the one or more location codes based on the first image, the second image, and the information indicating the specific location.

2. The method according to claim 1, wherein the detecting the one or more location codes comprises detecting, using an optical character recognition (OCR), the one or more location codes that are included in at least one of the first image or the second image.

3. The method according to claim 1, wherein the detecting the one or more location codes comprises:
detecting, using an optical character recognition (OCR), character information included in at least one of the first image or the second image; and
detecting, based on a location code pattern, the one or more location codes from the detected character information.

4. The method according to claim 1, wherein the detecting the one or more location codes comprises:
pre-processing the first image and the second image; and
detecting, based on the pre-processed first image and the pre-processed second image, the one or more location codes.

5. The method according to claim 4, wherein the pre-processing the first image and the second image comprises:
cropping the first image such that an area in the first image that is associated with the one or more location codes remain in the cropped first image; and
cropping the second image such that an area in the second image that is associated with the one or more location codes remain in the cropped second image.

6. The method according to claim 5, wherein the pre-processing the first image and the second image comprises:
extracting the area in the first image that is associated with the one or more location codes by performing an image segmentation on the first image; and
extracting the area in the second image that is associated with the one or more location codes by performing an image segmentation on the second image.

7. The method according to claim 5, wherein the one or more location codes comprises codes attached to racks to distinguish partitioned areas of the racks, and
the cropping the first image comprises cropping the first image by using physical information of the racks such that the area in the first image that is associated with the one or more location codes remain in the cropped first image; and
the cropping the second image comprises cropping the second image by using the physical information of the racks such that the area in the second image that is associated with the one or more location codes remain in the cropped second image.

8. The method according to claim 5, wherein the pre-processing the first image and the second image further comprises merging the cropped first image and the cropped second image.

9. The method according to claim 4, wherein the pre-processing the first image and the second image comprises removing noise from the first image and the second image.

10. The method according to claim 1, wherein the information indicating the specific location is location information estimated by the robot.

11. The method according to claim 1, wherein the estimating the location of each location code of the one or more location codes comprises:
determining three-dimensional (3D) location information of each location code of the one or more location codes with respect to the robot, based on the first image, the second image, and the information indicating the specific location; and
converting the 3D location information of each location code of the one or more location codes into global location information indicating a location of the one or more location codes in a global coordinate system.

12. The method according to claim 11, wherein the determining the 3D location information of each location code of the one or more location codes comprises:
determining, by using physical information of a subject captured in the first image or the second image and a focal length of the first monocular camera or the second monocular camera, the 3D location information of each location code of the one or more location codes.

13. The method according to claim 11, wherein the determining the 3D location information of each location code of the one or more location codes comprises determining, using triangulation, the 3D location information of each location code of the one or more location codes.

14. A method performed by one or more processors, the method comprising:
receiving a plurality of first images captured by a first monocular camera mounted on a robot, wherein each first image of the plurality of first images is captured at a location of a plurality of locations;
receiving a plurality of second images captured by a second monocular camera mounted on the robot, wherein each second image of the plurality of second images is captured at a location of the plurality of locations;
receiving information indicating the plurality of locations;
detecting, based on at least one of the plurality of first images or the plurality of second images, a plurality of location codes; and
estimating a location of each location code of the plurality of location codes based on the plurality of first images, the plurality of second images, and the information indicating the plurality of locations.

15. The method according to claim 14, further comprising performing at least one of:
removing an abnormal value from information of an estimated location of at least one location code of the plurality of location codes; or
correcting, based on a missing value, information of an estimated location of at least one location code of the plurality of location codes.

16. The method according to claim 15, wherein the removing the abnormal value comprises removing the abnormal value by clustering locations where images having the plurality of location codes are captured.

17. The method according to claim 15, wherein the removing the abnormal value comprises:
based on locations of a set of location codes of the plurality of location codes, which are estimated to be on a same straight line, approximating a linear function associated with the set of location codes; and
removing information of a location of a specific location code of the set of location codes, wherein the specific location code of the set of location codes has a residual from the linear function exceeding a predefined threshold.

18. The method according to claim 15, wherein the correcting the information of the estimated location of each location code of the plurality of location codes comprises:
based on locations of a set of location codes of the plurality of location codes, which are estimated to be on a same straight line, approximating a linear function associated with the set of location codes; and
compensating for the missing value based on information of a location of each location code of the set of location codes and the linear function.

19. The method according to claim 14, further comprising:
determining, based on the estimated location of each location code of the plurality of location codes, a picking location associated with each of the plurality of location codes.

20. The method according to claim 19, wherein the determining the picking location comprises determining a picking location associated with a specific location code, and
the determining the picking location associated with the specific location code comprises:
based on locations of a set of location codes estimated to be on a same straight line as the specific location code, approximating a linear function associated with the set of location codes; and
determining a picking location present on a normal of the linear function passing through a location of the specific location code.
